(19) United States
(12) Patent Application Publication
(10) Pub. No.: US 2026/0169819 A1
(43) Pub. Date: Jun. 18, 2026

(54) MACRO-CHANNEL RESOURCE ALLOCATION OPTIMIZATION

(71) Applicants: Leah T. Aldrich, Collinsville, CT (US); James A. Madison, Windsor, CT (US); George Mathew, Weatogue, CT (US)

(72) Inventors: Leah T. Aldrich, Collinsville, CT (US); James A. Madison, Windsor, CT (US); George Mathew, Weatogue, CT (US)

(21) Appl. No.: 18/982,029

(22) Filed: Dec. 16, 2024

(51) Int. Cl. G06F 9/50

(52) U.S. Cl. CPC G06F 9/5061; G06F 9/5027

(57) ABSTRACT

A resource allocation system for an enterprise may include a channel hierarchy data store that contains electronic records representing a plurality of channels for the enterprise, each channel including a plurality of sub-channels, and macro-channels that include sub-channels associated with multiple channels. A resource allocation data store may contain electronic records representing prior resource amounts and results for the plurality of channels in the channel hierarchy data store. A resource allocation tool may access information in the data stores and calculate absolute and marginal resource amounts for each macro-channel. The resource allocation tool can then automatically optimize future resource amounts and results among the macro-channels based on the absolute and marginal resource amounts. The resource allocation tool may also automatically provide each macro-channel with the associated optimized future resource amount.

### TECHNICAL FIELD

The present application generally relates to computer systems and more particularly to computer systems that are adapted to accurately, securely, and/or automatically support role-based multi-factor authentication enforcement scope changes for an enterprise.

### BACKGROUND

An enterprise may allocate resources among various channels. For example, FIG. 1 is an example 100 illustrating channels 110. Moreover, each channel 110 (C1, C2, etc.) can be associated with multiple sub-channels 110 (SC 1.1, SC 1.2, SC 1.3, etc.). Determining an appropriate allocation of resources to the sub-channels 110 within any particular channel 110 may be straightforward (e.g., it might be decided to allocate twice as many resources to SC 1.2 as compared to SC 1.1). It can be very difficult, however, to allocate appropriate resources among the sub-channels 120 associated with multiple channels. For example, it might be unclear how to determine appropriate resources for SC 2.3 as compared to SC 1.2—especially when there are a substantial number of channels 110 and/or sub-channels 120. It would be desirable to provide improved systems and methods to accurately and/or automatically support resource allocation for an enterprise. Moreover, the results should be easy to access, understand, interpret, update, etc.

### SUMMARY OF THE INVENTION

According to some embodiments, systems, methods, apparatus,

computer program code and means are provided to accurately and/or automatically support resource allocation for an enterprise in a way that provides fast, secure, and useful results and that allows for flexibility and effectiveness when responding to those results.

Some embodiments are directed to a resource allocation system for an enterprise that includes a channel hierarchy data store with electronic records representing a plurality of channels for the enterprise, each channel including a plurality of sub-channels, and macro-channels that include sub-channels associated with multiple channels. A resource allocation data store may contain electronic records representing prior resource amounts and results for the plurality of channels in the channel hierarchy data store. A resource allocation tool may access information in the data stores and calculate absolute and marginal resource amounts for each macro-channel. The resource allocation tool can then automatically optimize future resource amounts and results among the macro-channels based on the absolute and marginal resource amounts. The resource allocation tool may also automatically provide each macro-channel with the associated optimized future resource amount.

Some embodiments comprise: means for accessing information in a channel hierarchy data store that contains electronic records representing a plurality of channels for an enterprise, each channel including a plurality of sub-channels, and macro-channels that include sub-channels associated with multiple channels; means for accessing information in a resource allocation data store that contains electronic records representing prior resource amounts and results for the plurality of channels in the channel hierarchy data store; means for calculating absolute and marginal resource amounts for each macro-channel based on the channel hierarchy, prior resource amounts, and prior results; means for automatically optimizing future resource amounts and future resource results among the macro-channels based on the absolute and marginal resource amounts; and means for automatically providing each macro-channel with the associated optimized future resource amount.

In some embodiments, a communication device associated with a back-end application computer server exchanges information with remote devices in connection with interactive graphical user interfaces. The information may be exchanged, for example, via public and/or proprietary communication networks.

A technical effect of some embodiments of the invention is improved and computerized support of enterprise resource allocation that provides fast, secure, and useful results. With these and other advantages and features that will become hereinafter apparent, a more complete understanding of the nature of the invention can be obtained by referring to the following detailed description and to the drawings appended hereto.

### BRIEF DESCRIPTION OF THE DRAWINGS

FIG. 1 is an example 100 illustrating channels 110.

FIG. 2 is a high-level block diagram of an enterprise system in accordance with some embodiments.

FIGS. 3 and 4 illustrate resource allocation according to some embodiments.

FIGS. 5A and 5B illustrate the use of marginal resource allocation deciles according to some embodiments.

FIGS. 6 through 8 illustrate dual hierarchy integration in accordance with some embodiments.

FIGS. 9 and 10 illustrate integration of fixed and variable costs according to some embodiments.

FIGS. 11 through 13 illustrate integration with forecasting in accordance with some embodiments.

FIGS. 14 through 17 illustrate automated hypothetical scenarios according to some embodiments.

FIGS. 18 through 20 illustrate transactional and analytical integration in accordance with some embodiments.

FIGS. 21 through 24 illustrate capacity adjustments according to some embodiments.

FIGS. 25 through 27 illustrate quality adjustments in accordance with some embodiments.

FIGS. 28 and 29 illustrate constraint capping according to some embodiments.

FIGS. 30 through 32 illustrate infrastructure alignment in accordance with some embodiments.

FIG. 33 is an operator or administrator display according to some embodiments.

FIG. 34 is a block diagram of an apparatus in accordance with some embodiments.

FIG. 35 is a portion of a channel hierarchy database according to some embodiments.

FIG. 36 is a portion of a resource allocation database according to some embodiments.

FIG. 37 is a tablet computer according to some embodiments.

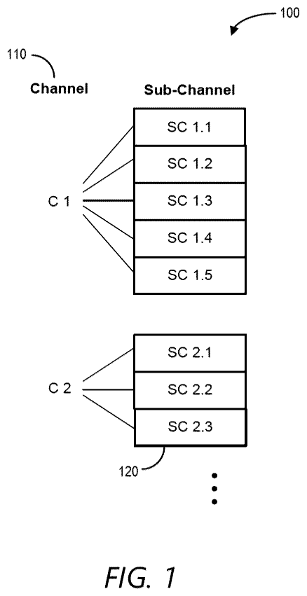

### DETAILED DESCRIPTION

Before the various exemplary embodiments are described in

further detail, it is to be understood that the present invention is not limited to the particular embodiments described. It is also to be understood that the terminology used herein is for the purpose of describing particular embodiments only and is not intended to limit the scope of the claims of the present invention.

In the drawings, like reference numerals refer to like features of the systems and methods of the present invention. Accordingly, although certain descriptions may refer only to certain figures and reference numerals, it should be understood that such descriptions might be equally applicable to like reference numerals in other figures.

The present invention provides significant technical improvements to facilitate data processing associated with a resource allocation system. The present invention is directed to more than merely a computer implementation of a routine or conventional activity previously known in the industry as it provides a specific advancement in the area of resource allocation by providing improvements in the operation of a computer system that automatically implements appropriate resource allocations. The present invention provides improvement beyond a mere generic computer implementation as it involves the novel ordered combination of system elements and processes to provide improvements in the speed, security, and accuracy of such a resource allocation tool for an enterprise. Some embodiments of the present invention are directed to a system adapted to automatically handle third-party data, aggregate information from multiple data sources, automatically generate allocations in a way that reduces unnecessary messages or communications, etc. (e.g., to consolidate communications between parties within an enterprise). Moreover, communication links and messages may be automatically established, aggregated, formatted, modified, removed, exchanged, etc. to improve network performance (e.g., by reducing an amount of network messaging bandwidth and/or storage required to create allocation workflows or alerts, improve security, reduce the size of data stores, more efficiently collect, present, and utilize resource allocation information and results, etc.).

An enterprise may allocate resources among various channels. For example, a marketing department of an insurer may spend money on various media channels to obtain business. The marketing leadership may seek to spend more money on the media channels that obtain a substantial amount of business (and less in channel that result in less business). Each channel (e.g., television and radio commercials, printed materials, social media advertising, email messages, etc.) may seek to optimize within itself the money that it has been allocated. However, it is another challenge for leadership to balance spending across multiple channels. Some embodiments described herein quantify the performance of the individual channels in a uniform way and calculate the most appropriate allocations.

It may be assumed that owners of the individual channels can optimize within their silo using the traditional mechanisms of good fiscal management. Embodiments described herein may result in an optimization of resource allocation across multiple channels in ways that individual channel owners cannot do themselves. Note that embodiments are not precluded from working in connection with channels that are similar in nature, but they may be particularly useful when the channels have substantially different operating characteristics (such as the slow and predictable nature of direct mail versus the quick and variable nature of internet searches).

Embodiments may leverage several large-scale enterprise platforms and presume a level of organizational complexity that warrants putting such a system in place. It may support a number of channels (and complexity of channel hierarchies) that could reasonably be performed by experts simply sharing information and understanding the overall implications of cross-channel spending in a timely manner.

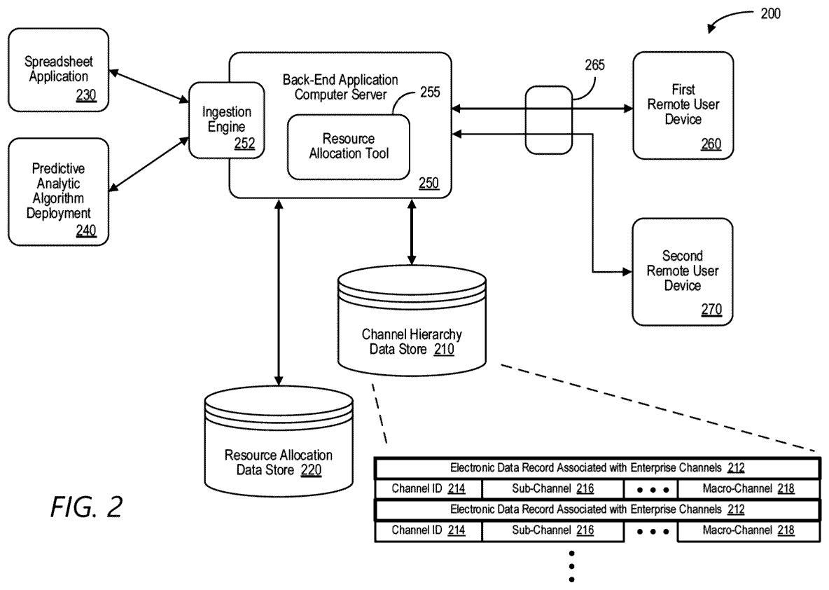

FIG. 2 is a high-level block diagram of an enterprise system 200 that may be provided according to some embodiments of the present invention. In particular, the system 200 includes a back-end application computer server 250 that may access information in a channel hierarchy data store 210 (e.g., storing a set of electronic records associated with enterprise channels 212, each record including, for example, one or more channel identifiers 214, sub-channel identifiers 216, macro-channel identifiers 218, etc.). The back-end application computer server 250 may also store information into other data stores, such as resource allocation data store 220, and utilize an ingestion engine 252 and a resource allocation tool 255 to exchange and process messages and view, analyze, and/or update electronic records. The back-end application computer server 250 may also exchange information with a first remote user device 260 and a second remote user device 270 (e.g., via a firewall 265). According to some embodiments, an interactive graphical user interface platform of the back-end application computer server 250 may facilitate the creation and review of resource allocation information, recommendations, alerts, and/or the display of results via one or more remote administrator computers (e.g., to summarize system 200 performance) and/or the remote user devices 260, 270. For example, the first remote user device 260 may transmit annotated and/or updated information to the back-end application computer server 250. Based on the updated information, the back-end application computer server 250 may adjust data in the channel hierarchy data store 210 and/or the resource allocation data store 220 and the changes may (or may not) be used in connection with the second remote user device 270. Note that the back-end application computer server 250 and/or any of the other devices and methods described herein might be associated with a third party, such as a vendor that performs a service for an enterprise. In some cases, the ingestion engine 252 may receive information in connection with a spreadsheet application 230 (e.g., the MICROSOFT™ EXCEL® spreadsheet application) and/or predictive analytic algorithm deployment 240. Although a spreadsheet application might be utilized, it can be backed up by a large amount of code, servers, and platforms.

The back-end application computer server 250 and/or the other elements of the system 200 might be, for example, associated with a Personal Computer (“PC”), laptop computer, smartphone, an enterprise server, a server farm, and/or a database or similar storage devices. According to some embodiments, an “automated” back-end application computer server 250 (and/or other elements of the system 200) may facilitate the automated access and/or update of electronic records in the data stores 210, 220 and/or the automated management of resource allocation (e.g., via workflow, calendar, and/or accounting servers). As used herein, the term “automated” may refer to, for example, actions that can be performed with little (or no) intervention by a human.

Devices, including those associated with the back-end application computer server 250 and any other apparatus described herein, may exchange information via any communication network which may be one or more of a Local Area Network (“LAN”), a Metropolitan Area Network (“MAN”), a Wide Area Network (“WAN”), a proprietary network, a Public Switched Telephone Network (“PSTN”), a Wireless Application Protocol (“WAP”) network, a Bluetooth network, a wireless LAN network, and/or an Internet Protocol (“IP”) network such as the Internet, an intranet, or an extranet. Note that any devices described herein may communicate via one or more such communication networks.

The back-end application computer server 250 may store information into and/or retrieve information from the channel hierarchy data store 210 and/or the resource allocation data store 220. The data stores 210, 220 may be locally stored or reside remote from the back-end application computer server 250. As will be described further below, the channel hierarchy data store 210 may be used by the back-end application computer server 250 in connection with an interactive user interface to facilitate resource allocation for an enterprise. Although a single back-end application computer server 250 is shown in FIG. 2, any number of such devices may be included. Moreover, various devices described herein might be combined according to embodiments of the present invention. For example, in some embodiments, the back-end application computer server 250 and channel hierarchy data store 210 might be co-located and/or may comprise a single apparatus.

The elements of the system 200 may work together to perform the various embodiments of the present invention. Note that the system 200 of FIG. 2 is provided only as an example, and embodiments may be associated with additional elements or components. According to some embodiments, the elements of the system 200 automatically transmit information associated with an interactive user interface display over a distributed communication network.

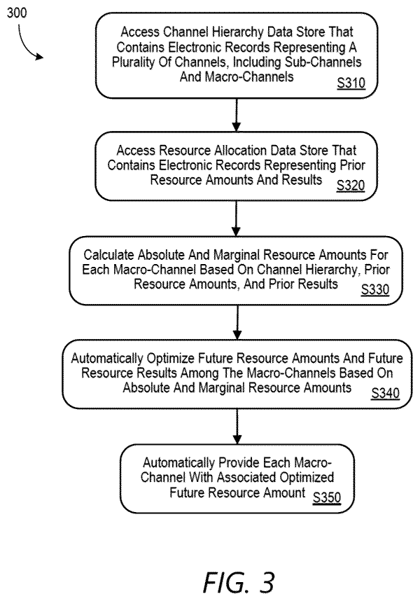

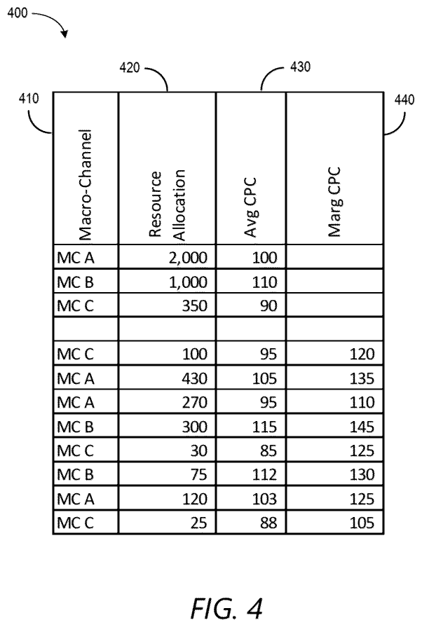

FIGS. 3 and 4 illustrate resource allocation according to some embodiments. In particular, FIG. 3 is a resource allocation method 300 that might be performed by some or all of the elements of the system 200 described with respect to FIG. 2, or any other system, according to some embodiments of the present invention. The flow charts described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein.

At S310, a computer processor of a resource allocation tool accesses information in a channel hierarchy data store. The channel hierarchy data store may contain electronic records representing a plurality of channels for the enterprise (each channel including a plurality of sub-channels). Moreover, macro-channels might include sub-channels that are associated with multiple channels. At S320, the computer processor of the resource allocation tool accesses information in a resource allocation data store. The resource allocation data store may contain, for example, electronic records that represent prior resource amounts and results for the plurality of channels in the channel hierarchy data store.

At S330, the system may calculate absolute and marginal resource amounts for each macro-channel based on the channel hierarchy, prior resource amounts, and prior results. At S340, the system automatically optimizes future resource amounts and future resource results among the macro-channels based on the absolute and marginal resource amounts. In some embodiments, each macro-channel can then be automatically provided with the associated optimized future resource amount at S350.

In this way, a mechanism of measuring both the absolute and marginal return on value for transactional events that occur within channels may be provided. For example, FIG. 4 is a table 400 that shows, on an overall macro-channel basis 410, a resource allocation 420 and an average Cost-Per-Conversion 430 (“CPC”). As used herein, the phrases CPC or cost-per-action may refer to an advertising measurement and pricing model referring to customer acquisition. The CPC may be a top-level metric that can be tracked across various channels, campaigns, or other situations where two or more quotes exist. Note that the CPC can be both absolute and marginal. As an example, if an enterprise operates for one day and gets a CPC of $1,000, the enterprise might conclude that the next day more should be spent (to get more conversions but at a higher cost). If the enterprise could get 10% more conversions for 10% more cost, there would still be a $1,000 CPC.

However, markets generally don't work that way because business gets tighter at the margin, so getting 10% more conversions will require more than 10% cost (and the marginal CPC be more than $1,000). As a result, in some embodiments the table 400 also includes information about marginal CPC 440 on a channel or sub-channel basis. Thus, embodiments may utilize both average CPC 430 and marginal CPC 440 that work together. MC A, MC B, and MC C all determine average and marginal CPC 430, 440, and these are used as inputs to various calculations to achieve balancing across channels.

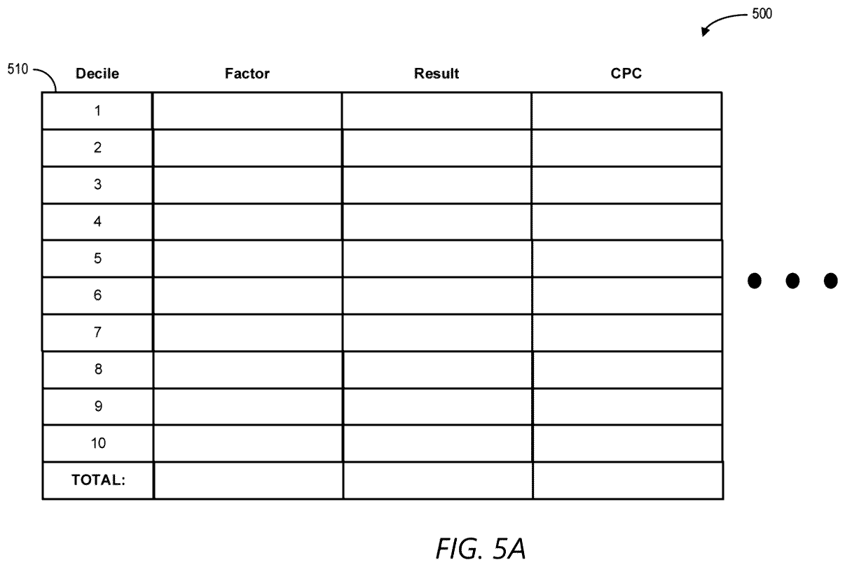

FIGS. 5A and 5B illustrate the use of marginal resource allocation deciles according to some embodiments. As used herein, the term “decile” may refer to values that divide sorted data into ten equal parts (so that each part represents one tenth of the data). Some embodiments use deciles and/or extensive marketing data to know who to target. FIG. 5A is a table 500 listing each decile 510 along with factors, results, and CPC values. Note that the result (e.g., cumulative CPC) from the resource allocation decile 510 one to decile 510 two might comprise a substantial increase, but the result between resource allocation decile 510 nine to decile 510 ten might be substantially lower (and so on in the middle of the deciles 510). This results in a curve 502 illustrated 501 in FIG. 5B. In this way, embodiments may recognize the notions of average and marginal CPC and calculate them in accordance with the channel hierarchy, the top level of which are the macro-channels.

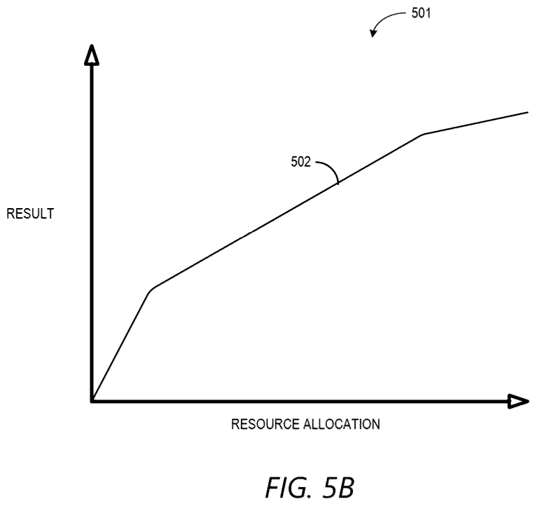

FIGS. 6 through 8 illustrate dual hierarchy integration (that is both channel and resource hierarchies) in accordance with some embodiments. In particular, FIG. 6 is a dual hierarchy integration method 600. At S610, the system associates information in a resource allocation data store with a resource hierarchy. It can then optimize based on the channel hierarchy and the resource hierarchy separately at 620. At 630, the system may optimize based on the channel hierarchy and the resource hierarchy together. Such an approach may allow for the separation and integration of operational and financial hierarchies so that the two can be optimized both independently and in a connected manner.

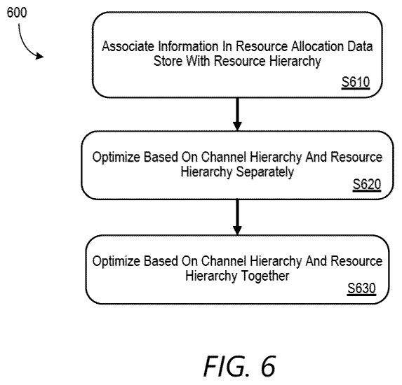

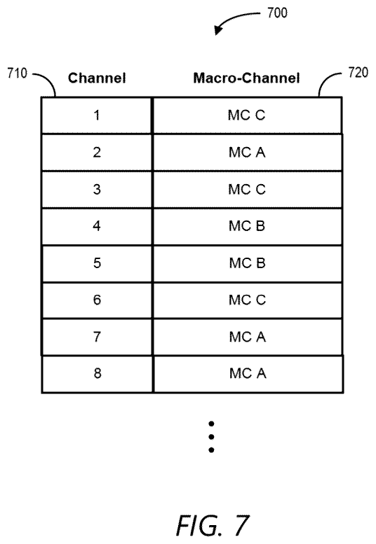

FIG. 7 is a table 700 listing, for multiple channels 710, an associated macro-channel 720. The channels 710 may represent the core of the operational hierarchy (how the enterprise actually does marketing). For example, does the enterprise place printed advertisements in a particular magazine and/or mail printed advertisements to the postal addresses of potential customers? At the macro-channel 720 level, both of those might be classified as “print.” At the channel 710 level, the system may have the granularity of how the enterprise does marketing (but the macro-channels 720 roll it up to show how the enterprise manages finances). That can also be seen in the illustration 800 of FIG. 8. The illustration shows various channels 810 (e.g., direct mail and online advertising), each with multiple sub-channels 820 (e.g., various web sites for the online advertising). Moreover, macro-channels 830 further categorize the sub-channels 820 (and may group sub-channels 820 that are associated with multiple channels 810). In this way, some embodiments may provide hierarchies for both driving operations and driving financials and strategy (and they work together). Note that business logic rules may be associated with the lines between sub-channels 820 and macro-channels 830 in FIG. 8. For example, SC 1.4 and SC 2.1 might have different CPCs and be of varied sizes, so the enterprise might apply a weighted average to the size of the pieces (media description, campaigns, etc.) to get an average CPC for media groups as the macro-channels 830 are rolled up.

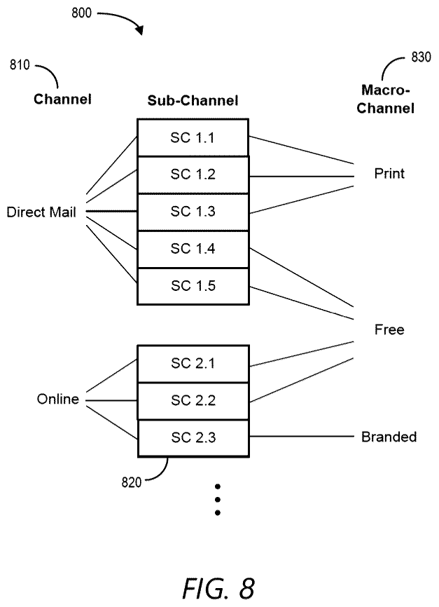

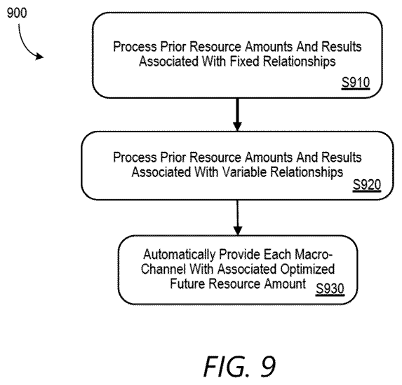

FIGS. 9 and 10 illustrate integration of fixed and variable costs according to some embodiments. In particular, FIG. 9 is an integration of fixed and variable costs method 900. In S910, the prior resource amounts and results are processed in connection with fixed relationships (e.g., traditional print advertising). In S920, the prior resource amounts and results are processed in connection with variable relationships (e.g., online advertising). Each macro-channel might then be automatically provided with an associated optimized future resource amount at S930. Such an approach may provide a mechanism for considering both fixed and variable costs that allows for the handling of variable costs on a frequent basis in the context of fixed costs being adjusted less frequently. FIG. 10 is an example 1000 including a spend for fixed category table 1010 and a call volume for fixed category table 1020 (e.g., for print advertising, television commercials, etc.). By getting all of the fixed and variable costs to line up, a unified financial view enabling marking via fixed cost methods (e.g., mailing packs to home addresses) and variable cost methods (e.g., searches on a web site where rules can be changed in substantially “real time”).

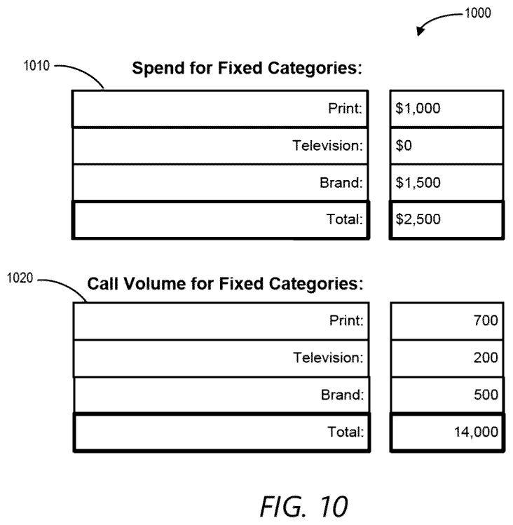

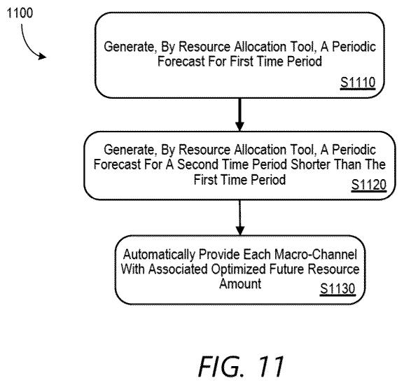

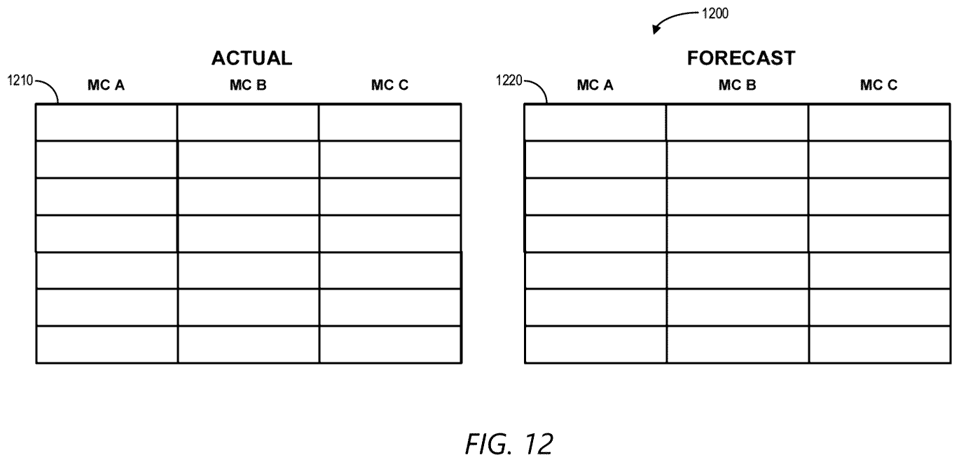

FIGS. 11 through 13 illustrate integration with forecasting in accordance with some embodiments. In particular, FIG. 11 is an integration with forecasting method 1100. At 1110, a resource allocation tool periodically generates a forecast for a first time period (e.g., annually). At 1120, the resource allocation tool periodically generates a forecast for a second time period shorter than the first time period (e.g., monthly). Each macro-channel might then be automatically provided with an associated optimized future resource amount at S1130. Such an approach may provide a mechanism of integrating forecasting both at the start of a cycle, typically annually, as well as throughout a faster cycle, typically monthly. FIG. 12 is an example 1200 including an actual report table 1210 and a forecast report table 1220 for various macro-channels. FIG. 13 is an example 1300 that includes monthly forecast tables 1310, 1320, 1330 showing spend, share, CPC, etc. for the macro-channels according to some embodiments. The date logic and overall structure provides a rolling ability to bring together the actual report table 1210 values and the forecast report table 1220 values in a way that rolls forward in time to show fiscal impact across fixed and variable CPC categories. Moreover, some embodiments may provide a mechanism for overlaying the to-date actuals with forecasted values to provide a rolling point-in-time view through the end of the various cycle times (such as both monthly and projected year-end). Although monthly and year to date are used as examples, embodiments may utilize other time periods (e.g., weekly or quarterly) and roll as far out as needed.

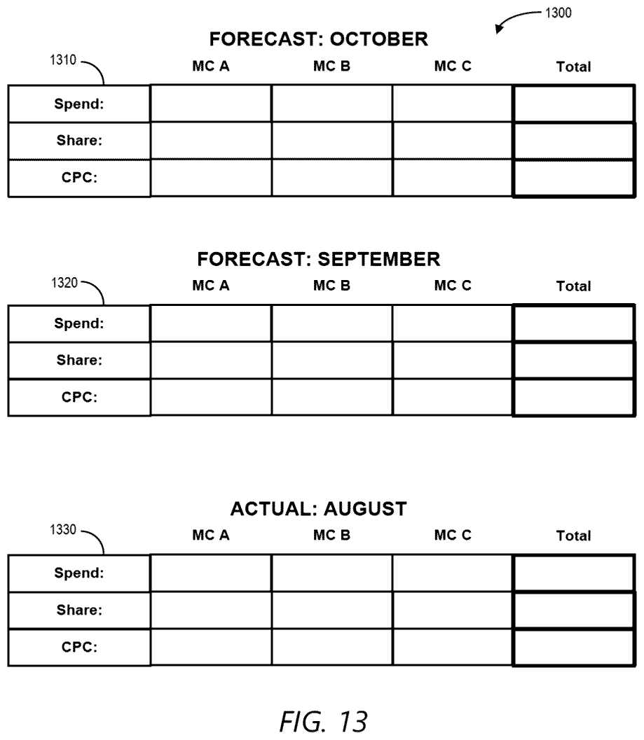

FIGS. 14 through 17 illustrate automated hypothetical scenarios according to some embodiments. In particular, FIG. 14 is an automated hypothetical scenario method 1400. At 1410, a resource allocation tool receives hypothetical parameters (e.g., from a marketing employee of an enterprise), At 1420, the resource allocation tool automatically generates a forecast for multiple hypothetical scenarios. Each macro-channel might then be automatically provided with an associated optimized future resource amount at S1430. The ability for domain experts to select fine-grain actions (and have the solution immediately) shows the fiscal impact from current operations through a future point (e.g., year-to-date).

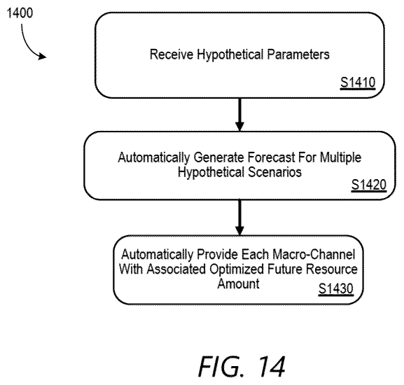

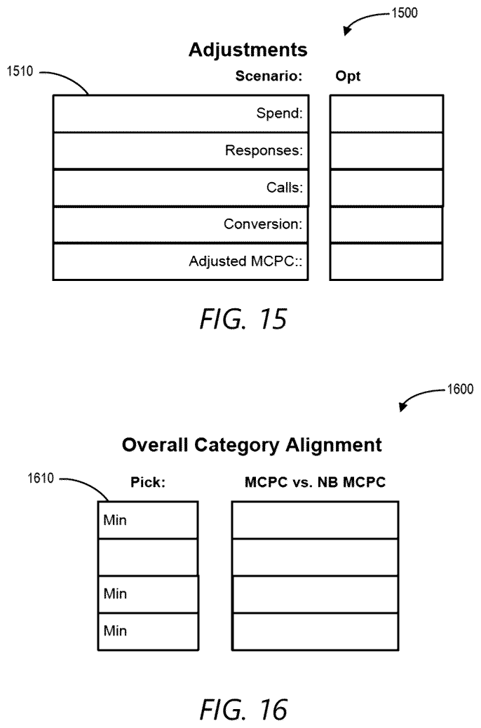

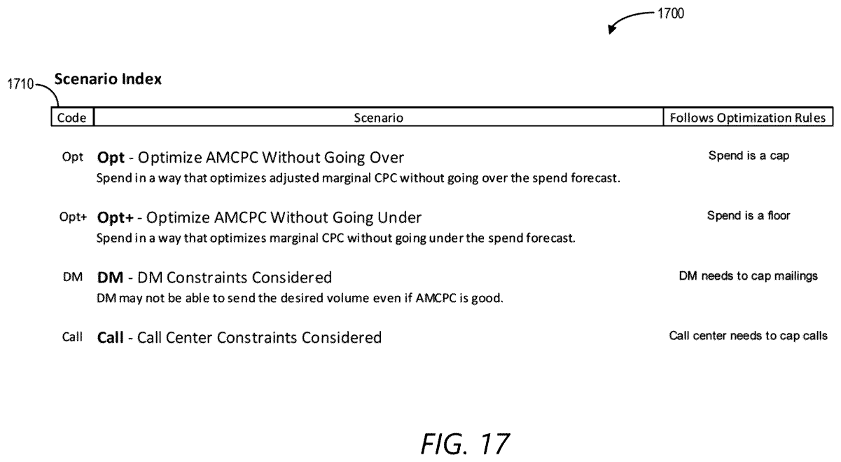

FIG. 15 is an example 1500 including a table 1510 showing adjustments for a hypothetical scenario named “opt” (for “optimal”) including spend, responses, calls, conversion, an adjusted Marginal Cost-Per-Click (“MCPC”), etc. FIG. 16 is an example 1600 including a table 1610 showing overall category alignment including selections for various groups (e.g., “min”) and associated MCPC information. This can be performed for multiple hypothetical scenarios (e.g., each with unique optimization rules) as illustrated by the table 1710 in the example 1700 shown in FIG. 17.

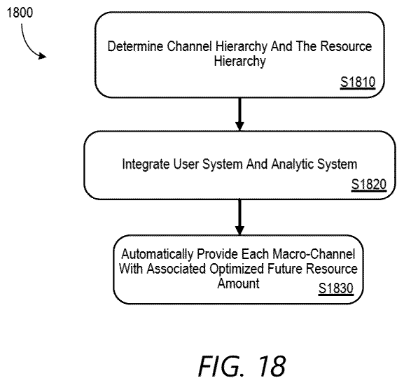

FIGS. 18 through 20 illustrate transactional and analytical integration in accordance with some embodiments. In particular, FIG. 18 is a transactional and analytical integration method 1800. At S1810, a channel hierarchy and the resource hierarchy are determined. At S1820, a user system and an analytic system are integrated based on the channel hierarchy and the resource hierarchy. Each macro-channel may then be automatically provided with an associated optimized future resource amount at S1830.

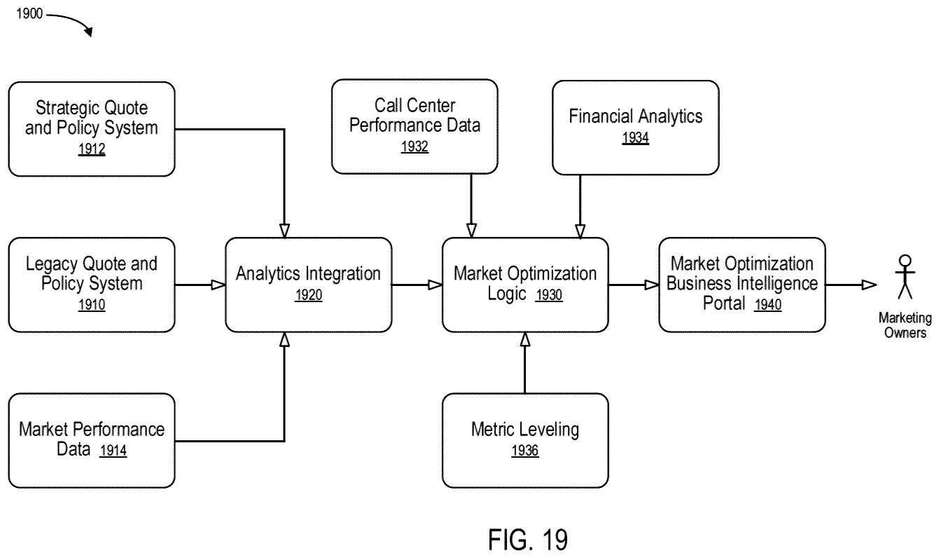

FIG. 19 is an insurance enterprise system 1900 that integrates transactional customer-facing systems with analytic systems at the levels defined in the operational and financial hierarchies. A legacy quote and policy system is 1910 provides quote data, and a strategic quote and policy system 1912 also provides quote data via a warehouse. Market performance data 1914 might indicate how the enterprise is actually working (e.g., for direct mailings). Analytics integration 1920 brings all of these diverse types of marketing data together. Market optimization logic 1930 is also integrating (in a lighter or more customized fashion) center performance data 1932 (how a call center is managing the business that marketing is creating), financial analytics 1934 (the targets that drive marketing through Snowflake), and metric leveling 1936 (computations around marginal CPC). Information generated by the market optimization logic 1930 can be provided to marketing owners via a market optimization business intelligence portal 1940.

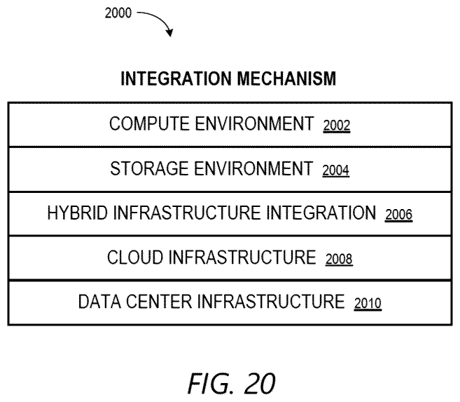

FIG. 20 shows an integration mechanism structure 2000 in accordance with some embodiments. A compute environment 2002 might include a predictive analytic algorithm deployment framework, Python, and compute aspects of cloud-based data storage (e.g., SNOWFLAKE®). A storage environment 2004 may include object storage through a web service interface (e.g., AMAZON™ Simple Storage Serv ice (“S3”)) and aspects of cloud-based data storage (e.g., SNOWFLAKE®). Hybrid infrastructure integration 2006 might run on both ORACLE® and SNOWFLAKE® in a way that naturally leverages other enterprise platforms. A cloud infrastructure 2008 might comprise, for example, the use of on-demand cloud computing platforms and APIs (e.g., the AMAZON™ Web Service (“AWS”)). Data center infrastructure 2010 might include the use of ORACLE®.

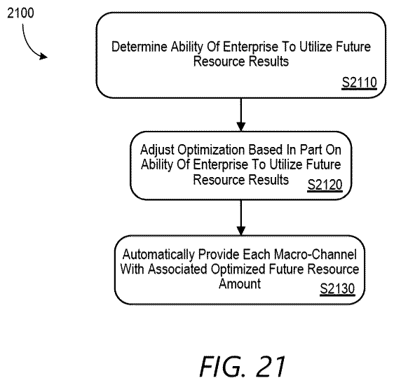

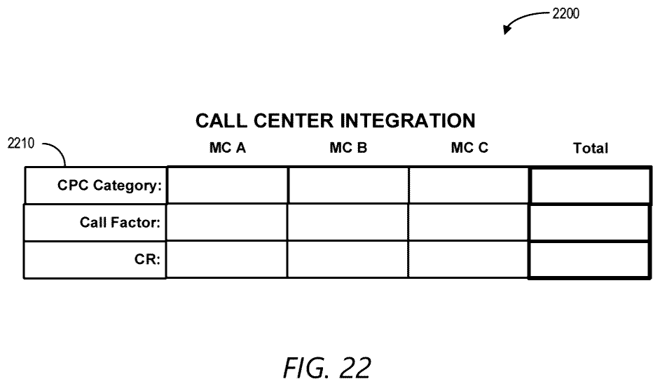

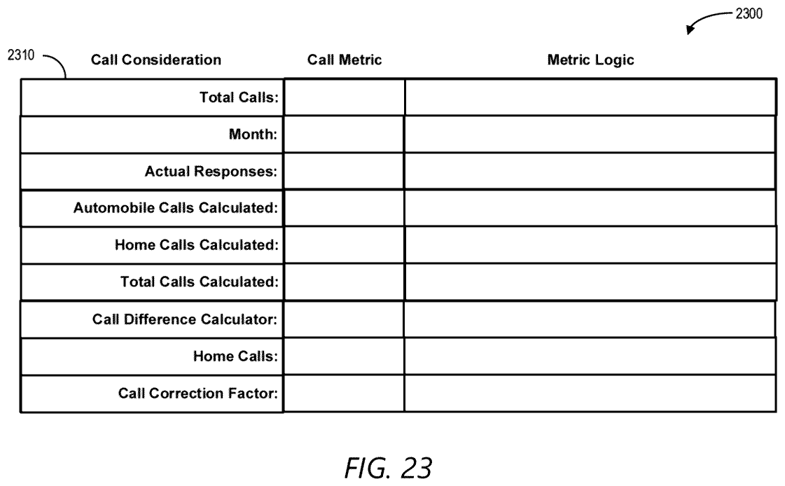

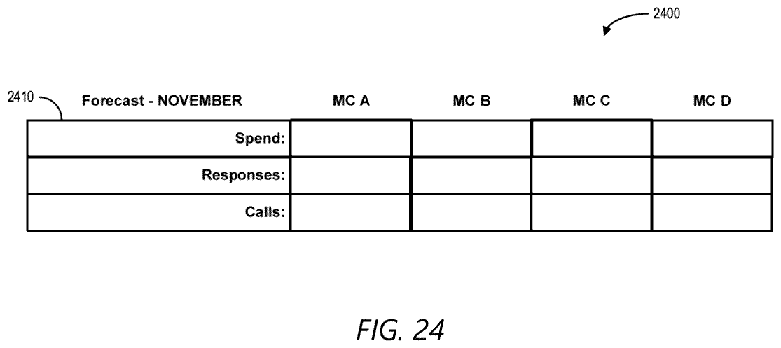

FIGS. 21 through 24 illustrate capacity adjustments according to some embodiments. In particular, FIG. 21 is a capacity adjustment method 2100. At S2110, an ability of an enterprise to utilize future resource results may be determined. At S2120, optimizing is performed based in part on this ability. Each macro-channel might then be automatically provided with an associated optimized future resource amount at S2130. For example, an ability to adjust marketing activity might be based on whether a call center can manage the transactional intensity created by marketing. (marketing generates customer responses, which puts load on the call center). FIG. 22 is an example 2200 including a call center integration table 2210 showing CPC categories, call factors, etc. across macro-channels. This information may then be hooked back into a forecast. FIG. 23 is an example 2300 including a metric table 2310 showing total calls, actual responses, home calls, call correction factors, etc. which propagates down into hypothetical scenarios as shown by the example 2400 of FIG. 24 which illustrates a monthly forecast table 2410 (e.g., including spend, responses, calls, etc.) across multiple macro-channels. The logic in the metric table 2310 might incorporate substantial mathematical considerations of call center capacity to throttle marketing.

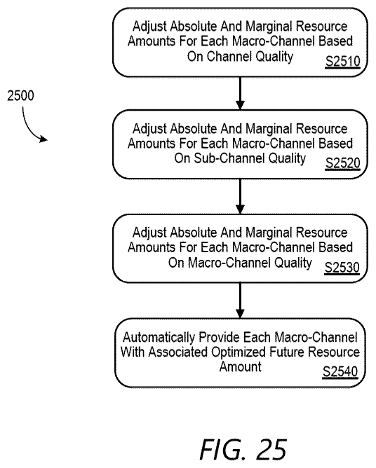

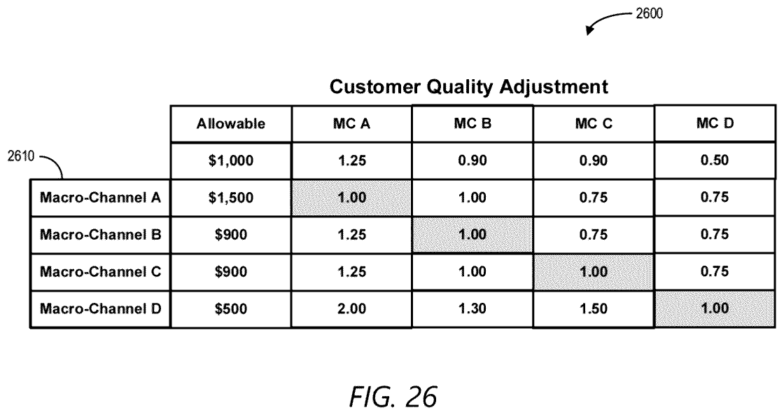

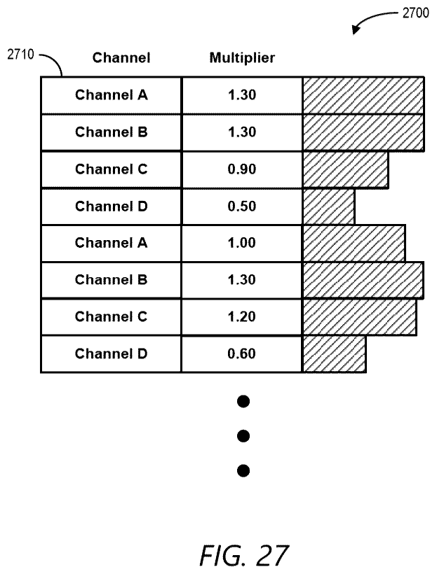

FIGS. 25 through 27 illustrate quality adjustments in accordance with some embodiments. In particular, FIG. 25 is a quality adjustment method 2500. At S2510, absolute and marginal resource amounts for each macro-channel are adjusted based on qualities of channels. At S2520, absolute and marginal resource amounts for each macro-channel are adjusted based on qualities of sub-channels. At S2530, absolute and marginal resource amounts for each macro-channel are adjusted based on qualities of macro-channels. Each macro-channel might then be automatically provided with an associated optimized future resource amount at S2540. FIG. 26 is an example 2600 including a customer quality adjustment table 2610 taking into consideration relationships between multiple macro-channels. The table 2610 provides a mechanism for adjusting the absolute and marginal returns based on the relative quality of the business across the individual channels so that a common quantification exists across all of the channels. Note that with some things, such as direct mailing, might be carefully selected for customers allowing for an improved conversion rate and CPC. Other things, such as television advertisements, do not generally have that ability and the table 2610 adjusts for this. The quality relativities in the table might be used to optimize for conversions or any other metric. FIG. 27 is an example 2700 including a channel multiplier table 2710. Note that embodiments might take customer lifetime value into consideration when determining customer quality and/or throttle marketing.

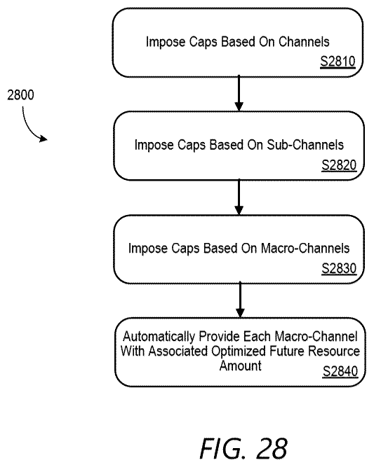

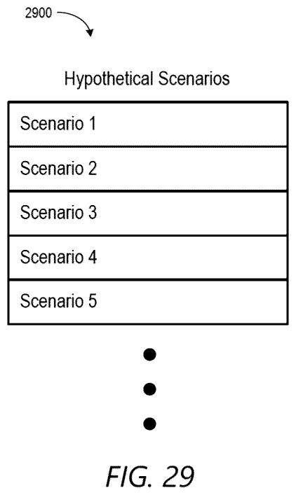

Some embodiments impose constraint limits or “caps” in connection with an optimization process (e.g., a monetary limit). FIGS. 28 and 29 illustrate constraint capping according to some embodiments. In particular, FIG. 28 is a constraint capping method 2800. At S2810, caps are imposed based on channels. At S2820, caps are imposed based on sub-channels. At S2830, caps are imposed based on macro-channels. Each macro-channel might then be automatically provided with an associated optimized future resource amount at S2840. For example, embodiments might impose caps on marketing activities across individual channels based on constraints that are inherent in the marketing process (there may be a limited audience of people to receive marketing). According to some embodiments, throttling may be adjust for various hypothetical scenarios 2900 such as those listed in FIG. 29.

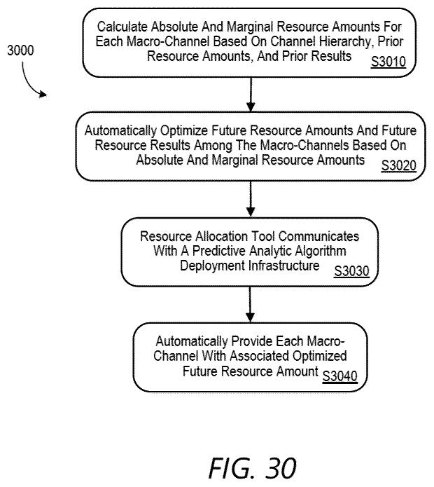

FIGS. 30 through 32 illustrate infrastructure alignment in accordance with some embodiments. In particular, FIG. 30 is an infrastructure alignment method 3000. At S3010, the system may calculate absolute and marginal resource amounts for each macro-channel based on the channel hierarchy, prior resource amounts, and prior results. At S3020, the system automatically optimizes future resource amounts and future resource results among the macro-channels based on the absolute and marginal resource amounts. At S3030, the resource allocation tool communicates with a predictive analytic algorithm deployment infrastructure that might include an analytics computing environment data store and/or an analytics environment computer (e.g., to initiate deployment of a predictive analytic algorithm in an enterprise operations workflow). Each macro-channel can then be automatically provided with the associated optimized future resource amount at S3040.

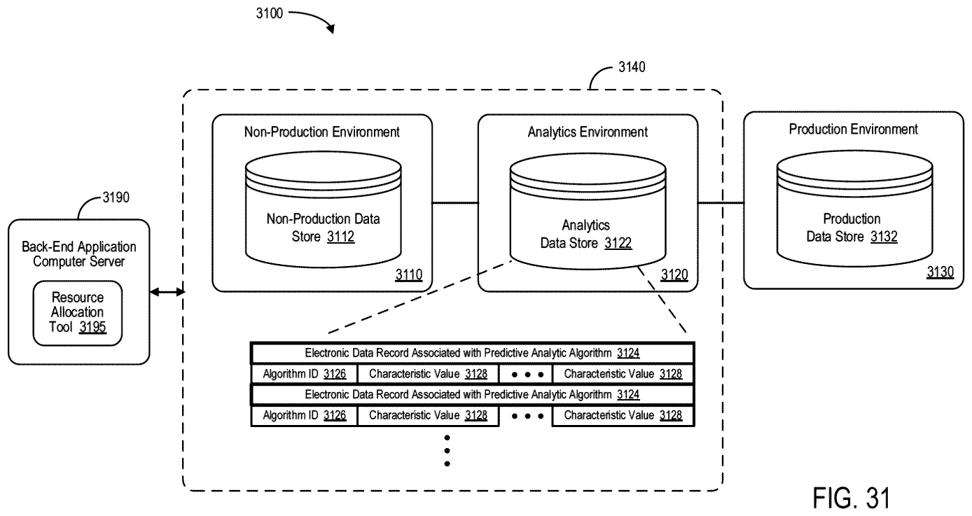

In this way, embodiments may utilize an analytics platform for analytics and enterprise integration. Some embodiments may integrate with a collection of enterprise content management and knowledge management tools (e.g., MICROSOFT™ SHAREPOINT® and AZURE® cloud security). FIG. 31 is a high-level block diagram of a system 3100 according to some embodiments of the present invention. In particular, the system 3100 includes a non-production environment 3110 with a non-production data store 3112 and a production environment 3130 with a production data store 3132. According to some embodiments, the system 3100 further includes a backend application computer server 3190 with a resource allocation tool 3195 that communicates with a predictive analytic algorithm deployment framework 3140, an analytics environment 3120, and/or an analytics data store 3122.

Note that the analytics environment 3120 (and/or other components of the system 3100) may also exchange information with a remote user terminal. Moreover, a central repository (not illustrated in FIG. 31) might be used to store the results of such algorithms. According to some embodiments, the analytics environment 3120 (and/or other devices described herein) might be associated with a third party, such as a vendor that performs a service for an enterprise.

The analytics environment 3120 may store information into and/or retrieve information from the analytics data store 3122. The analytics data store 3122 might, for example, store electronic records associated with various analytic algorithm components 3124, including, for example, algorithm identifiers 3126 and component characteristic values 3128 (e.g., associated with inputs, outputs, business rules or logic, etc.). The analytics data store 3122 may be locally stored or reside remote from the analytics environment 3120. The analytics data store 3122 may be used by the analytics environment to help deploy and manage algorithms for an enterprise.

Traditionally, a non-production environment 3110 may be relatively flexible but insecure as compared to a production environment 3130. According to some embodiments, the analytics environment 3120 may provide a specific combination of other two types of environments 3110, 3130 (e.g., by using data security associated with production, and table creation, code writing, and other “object rights” of development). An analytic environment 3120 may help serve those doing business analytics, such as those in a data science role. Business analytics might be associated with, for example, statistical analysis (why is something happening?), forecasting (what if current trends continue?), predictive modeling (what will happen next?), and/or optimization (what is the best way to proceed?). The analytic environment 3120 may give users performing analytics and data science the usability, algorithms, compute power, storage capacity, data movement, and community enablement needed to be successful. According to some embodiments, large-scale enterprise operations may incorporate self-tuning, automated predictive analytics founded on end-to-end data quality using a unified self-service architecture.

Note that data scientists may produce predictive analytics models that let an enterprise, such as an insurance operation, take on risk based on possible future losses. Such predictions may traditionally be done on systems that are largely disconnected from the operational systems where customers are found, business is written, and/or profit is made. Moving predictive models from data science workflows to operations workflows traditionally takes many months; commonly over a year for sufficiently large business problems that impact a large portion of a book of business. Some embodiments described herein make the flow between the two workflows in real-time or substantially real-time.

The system 3100 of FIG. 31 is provided only as an example, and embodiments may be associated with additional elements or components. According to some embodiments, the elements of the system 3100 may automatically facilitate deployment of predictive analytic algorithms for an enterprise. For example, an analytics environment computer may receive data from an analytics computing environment data store. In some embodiments, the received data may be a set of electronic data records, each electronic data record being associated with a predictive analytic algorithm and including an algorithm identifier and a set of algorithm characteristic values. The analytics environment computer may also receive an adjustment to at least one of the set of algorithm characteristic values from a user associated with the enterprise. For example, a user might change an input, output, business logic, etc. via an interactive graphical interface. Deployment of the predictive analytic algorithm can then be initiated in an enterprise operations workflow. In some embodiments, an enterprise operations workflow computer may execute an operations workflow in association with the deployed predictive analytic algorithm to generate at least one result. The result may be used to automatically adjust at least one operating parameter of the deployed predictive analytic algorithm (e.g., to fine-tune the algorithm and improve performance for the enterprise). The deployed predictive analytic algorithm might also monitor the result and generate an alert signal when the result exceeds a boundary condition. The alert signal might, for example, be automatically transmitted to a user (or a role) for further investigation. The boundary condition might comprise, for example, a minimum threshold value, a maximum threshold value, a condition associated with a series of results, etc. that indicate the algorithm may not be operating as intended.

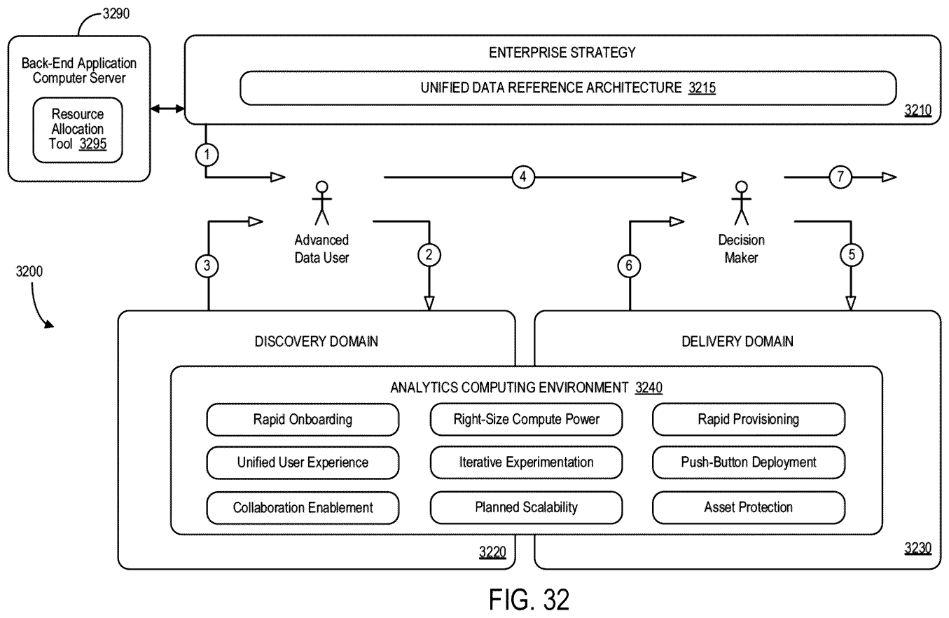

FIG. 32 illustrates an analytics computing environment 3200 in context in accordance with some embodiments. The environment 3200 includes a backend application computer server 3290 with a resource allocation tool 3295 that communicates with an enterprise strategy 3210 (e.g., including a unified data reference architecture 3215). Note that the environment 3200 may be the foundation of a discovery domain 3220 (e.g., publication, entitlements, visualization, policies, etc.), where business ideas may be shown to have value, and provide a direct path to a delivery domain 3230 (e.g., enterprise data warehouse, production workflows, etc.), where ideas become actions. In particular, an analytics computing environment 3240 (e.g., associated with value proposition, working areas, defined tooling, etc.) may help with that transition. According to some embodiments, the analytics computing environment 3240 may include rapid onboarding, a unified user experience, collaboration enablement, appropriate compute power, iterative experimentation, planned scalability, rapid provisioning, push-button deployment, and/or asset protection.

At (1), a mission may be provided from the enterprise strategy 3210 to an advanced data user. The advanced data user may then provide a hypothesis to the discovery domain 3220 at (2) and receive knowledge at (3). This process may be repeated until the advanced data user indicates a value to a decision maker at (4). The decision maker may then provide questions to the delivery domain at (5) and receive answers at (6). As a result of the answers, the decision maker can initiate an action at (7).

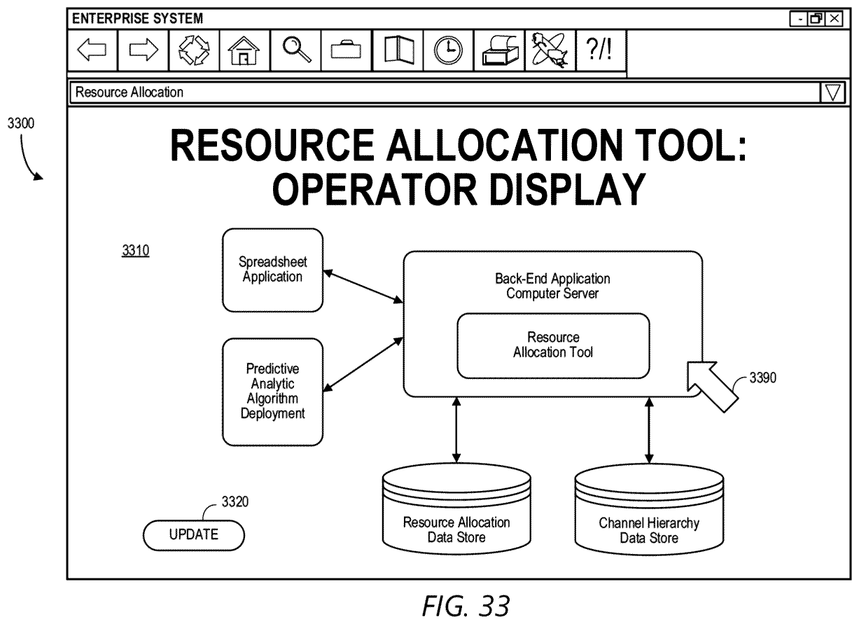

The operation of an enterprise resource allocation system may be controlled via a Graphical User Interface (“GUI”). For example, FIG. 33 is an enterprise resource allocation system operator or administrator display 3300 including graphical representations of elements of such a tool 3310 according to some embodiments. Selection of a portion or element of the display 3300 via a touchscreen or pointer 3390 might result in the presentation of additional information about that portion or element (e.g., a popup window presenting data mappings, macro-channel allocation recommendations, etc.) or let an operator or administrator enter or annotate additional information about resource allocation (e.g., based on changes to system configuration, new marketing information, call center data, etc.). An “Update” icon 3320 might let the administrator save updates and changes to the tool 3310.

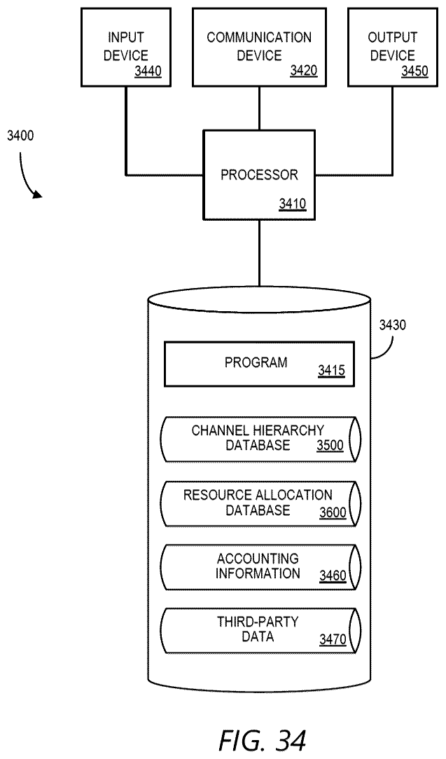

The embodiments described herein may be implemented using any number of different hardware configurations. For example, FIG. 34 illustrates an apparatus 3400 that may be, for example, associated with the enterprise resource allocation system 200 described with respect to FIG. 2 (or any other system described herein). The apparatus 3400 comprises a processor 3410, such as one or more commercially available Central Processing Units (“CPUs”) in the form of one-chip microprocessors, coupled to a communication device 3420 configured to communicate via a communication network (not shown in FIG. 34). The communication device 3420 may be used to communicate, for example, with one or more remote cloud or on-premises systems, administrators, enterprise employees, and/or communication devices (e.g., PCs and smartphones). Note that communications exchanged via the communication device 3420 may utilize security features, such as those between a public internet user and an internal network of an insurance company and/or an enterprise. The security features might be associated with, for example, web servers, firewalls, and/or PCI infrastructure. The apparatus 3400 further includes an input device 3440 (e.g., a mouse and/or keyboard to enter information about resource allocations, hypothetical scenarios, etc.) and an output device 3450 (e.g., to output reports regarding enterprise resource allocations, recommendations, alerts, etc.).

The processor 3410 also communicates with a storage device 3430. The storage device 3430 may comprise any appropriate information storage device, including combinations of magnetic storage devices (e.g., a hard disk drive), optical storage devices, mobile telephones, and/or semiconductor memory devices. The storage device 3430 stores a program 3415 and/or a resource allocation tool or application for controlling the processor 3410. The processor 3410 performs instructions of the program 3415, and thereby operates in accordance with any of the embodiments described herein. For example, the processor 3410 may calculate absolute and marginal resource amounts for each macro-channel. The resource allocation tool can then automatically optimize future resource amounts and results among the macro-channels based on the absolute and marginal resource amounts. The resource allocation tool may also automatically provide each macro-channel with the associated optimized future resource amount.

The program 3415 may be stored in a compressed, uncompiled and/or encrypted format. The program 3415 may furthermore include other program elements, such as an operating system, a database management system, and/or device drivers used by the processor 3410 to interface with peripheral devices.

As used herein, information may be “received” by or “transmitted” to, for example: (i) the apparatus 3400 from another device; or (ii) a software application or module within the apparatus 3400 from another software application, module, or any other source.

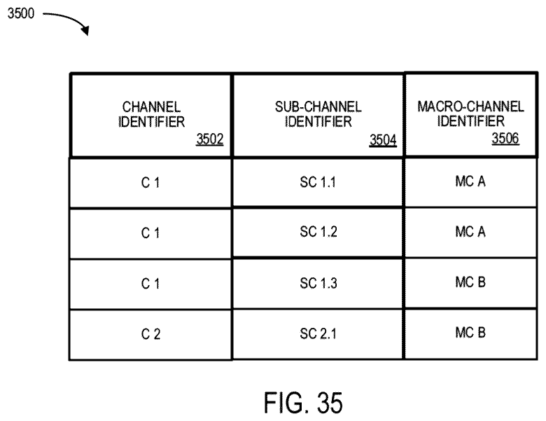

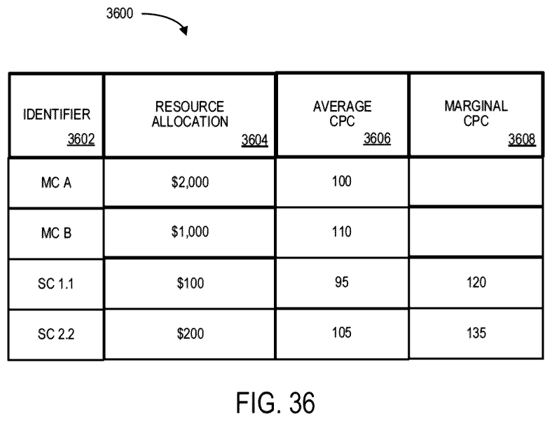

In some embodiments (such as shown in FIG. 34), the storage device 3430 further includes a channel hierarchy database 3500, a resource allocation database 3600, account information 3460 (e.g., prior marketing spends in various media channels), and third-party data 3470 (e.g., CPC related information). An example of databases that might be used in connection with the apparatus 3400 will now be described in detail with respect to FIGS. 35 and 36. Note that the databases described herein are only examples, and additional and/or different information may be stored therein. Moreover, various databases might be split or combined in accordance with any of the embodiments described herein. For example, the resource allocation database 3600 and the accounting information 3460 might be combined and/or linked to each other within the program 3415.

Referring to FIG. 35, a table is shown that represents the channel hierarchy database 3500 that may be stored at the apparatus 3400 according to some embodiments. The table may include, for example, entries associated with various media channels utilized by an enterprise. The table may also define fields 3502, 3504, 3506 for each of the entries. The fields 3502, 3504, 3506 may, according to some embodiments, specify: a channel identifier 3502, a sub-channel identifier 3504, and a macro-channel identifier 3506. The channel hierarchy database 3500 may be created and updated, for example, when macro-channels are defined or adjusted, a channel is added or removed, etc.

The channel identifier 3502 may be, for example, a unique alphanumeric code associated with a type of media (e.g., direct mail, online, print, telemarketing, etc.). The sub-channel identifier 3504 might be associated with a particular media group, and the macro-channel identifier 3506 may represent a CPC category.

Referring to FIG. 36, a table is shown that represents the resource allocation database 3600 that may be stored at the apparatus 3400 according to some embodiments. The table may include, for example, entries associated with different resource allocations. The table may also define fields 3602, 3604, 3606, 3608 for each of the entries. The fields 3602, 3604, 3606, 3608 may, according to some embodiments, specify: an identifier 3602, a resource allocation 3604, an average CPC 3606, and a marginal CPC 3608. The resource allocation database 3600 may be created and updated, for example, when new accounting information is received, a hypothetical scenario is evaluated, etc.

The identifier 3602 may be, for example, a unique alphanumeric code associated with a media channel, sub-channel, or macro-channel. The resource allocation 3604 may represent an amount of money spent on that media which can then be used to calculate the average CPC 3606 and marginal CPC 3608.

Thus, embodiments may continuously monitor, recommend, and/or automatically implement resource allocations for an enterprise. The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

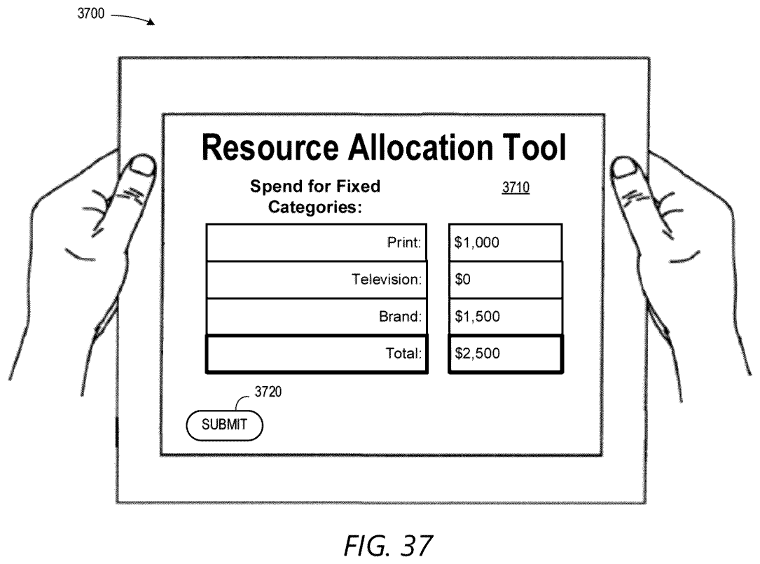

Although specific hardware and data configurations have been described herein, note that any number of other configurations may be provided in accordance with embodiments of the present invention (e.g., some of the information associated with the displays described herein might be implemented as a virtual or augmented reality display and/or the databases described herein may be combined or stored in external systems). Moreover, although embodiments have been described with respect to specific types of enterprises, embodiments may instead be associated with other types of financial enterprises, educational institutions, organizations, etc. instead. FIG. 37 illustrates a handheld tablet 3700 in accordance with some embodiments. A resource allocation tool display 3710 might, for example, let an operator review, modify or implement allocations associated with an enterprise via a “Submit” icon 3720.

The present invention has been described in terms of several embodiments solely for the purpose of illustration. Persons skilled in the art will recognize from this description that the invention is not limited to the embodiments described but may be practiced with modifications and alterations limited only by the spirit and scope of the appended claims.

What is claimed:

1. A resource allocation system for an enterprise, comprising:
(a) a channel hierarchy data store that contains electronic records representing a plurality of channels for the enterprise, each channel including a plurality of sub-channels, and macro-channels that include sub-channels associated with multiple channels;
(b) a resource allocation data store that contains electronic records representing prior resource amounts and results for the plurality of channels in the channel hierarchy data store; and
(c) a resource allocation tool, coupled to the channel hierarchy data store and the resource allocation data store, including:
a computer processor, and
a computer memory coupled to the computer processor and storing instructions that, when executed by the computer processor, cause a back-end application computer server associated with the resource allocation tool to:
access information in the channel hierarchy data store and the resource allocation data store,
calculate absolute and marginal resource amounts for each macro-channel based on the channel hierarchy, prior resource amounts, and prior results,
automatically optimize future resource amounts and future resource results among the macro-channels based on the absolute and marginal resource amounts, and
automatically provide each macro-channel with the associated optimized future resource amount.

2. The system of claim 1, wherein information in the resource allocation data store is associated with a resource hierarchy and said optimizing is performed both: (i) on the channel hierarchy and the resource hierarchy separately, and (ii) on the channel hierarchy and the resource hierarchy together.

3. The system of claim 1, wherein the prior resource amounts and results are associated with both: (i) fixed relationships, and (ii) variable relationships.

4. The system of claim 1, wherein the resource allocation tool periodically generates a forecast for each of: (i) a first time period, and (ii) a second time period shorter than the first time period.

5. The system of claim 1, wherein the resource allocation tool automatically generates a forecast for multiple hypothetical scenarios.

6. The system of claim 1, wherein a user system and an analytic system are integrated based on the channel hierarchy and the resource hierarchy.

7. The system of claim 1, wherein said optimizing is based in part on an ability of the enterprise to utilize the future resource results.

8. The system of claim 1, wherein the absolute and marginal resource amounts for each macro-channel are adjusted based on qualities of at least one of: (i) channels, (ii) sub-channels, and (iii) macro-channels.

9. The system of claim 1, wherein caps are imposed based on at least one of: (i) channels, (ii) sub-channels, and (iii) macro-channels.

10. The system of claim 1, wherein the resource allocation tool communicates with a predictive analytic algorithm deployment infrastructure that includes: (i) an analytics computing environment data store, and (ii) an analytics environment computer to initiate deployment of a predictive analytic algorithm in an enterprise operations workflow.

11. The system of claim 1, further comprising:
(d) a communication port coupled to the back-end application computer server to facilitate an exchange of data with a remote device via a distributed communication network to support interactive user interface displays that include information about the optimized future resource amounts.

12. A resource allocation method for an enterprise, comprising:
accessing, by a computer processor of a resource allocation tool, information in a channel hierarchy data store that contains electronic records representing a plurality of channels for the enterprise, each channel including a plurality of sub-channels, and macro-channels that include sub-channels associated with multiple channels;
accessing, by the computer processor of the resource allocation tool, information in a resource allocation data store that contains electronic records representing prior resource amounts and results for the plurality of channels in the channel hierarchy data store;
calculating absolute and marginal resource amounts for each macro-channel based on the channel hierarchy, prior resource amounts, and prior results;
automatically optimizing future resource amounts and future resource results among the macro-channels based on the absolute and marginal resource amounts; and
automatically providing each macro-channel with the associated optimized future resource amount.

13. The method of claim 12, wherein information in the resource allocation data store is associated with a resource hierarchy and said optimizing is performed both: (i) on the channel hierarchy and the resource hierarchy separately, and (ii) on the channel hierarchy and the resource hierarchy together.

14. The method of claim 12, wherein the prior resource amounts and results are associated with both: (i) fixed relationships, and (ii) variable relationships.

15. The method of claim 12, wherein the resource allocation tool periodically generates a forecast for each of: (i) a first time period, and (ii) a second time period shorter than the first time period.

16. The method of claim 12, wherein the resource allocation tool automatically generates a forecast for multiple hypothetical scenarios.

17. A non-transitory, computer-readable medium storing instructions, that, when executed by a processor, cause the processor to perform a resource allocation method for an enterprise, the method comprising:
accessing, by a computer processor of a resource allocation tool, information in a channel hierarchy data store that contains electronic records representing a plurality of channels for the enterprise, each channel including a plurality of sub-channels, and macro-channels that include sub-channels associated with multiple channels;
accessing, by the computer processor of the resource allocation tool, information in a resource allocation data store that contains electronic records representing prior resource amounts and results for the plurality of channels in the channel hierarchy data store;
calculating absolute and marginal resource amounts for each macro-channel based on the channel hierarchy, prior resource amounts, and prior results;
automatically optimizing future resource amounts and future resource results among the macro-channels based on the absolute and marginal resource amounts; and
automatically providing each macro-channel with the associated optimized future resource amount.

18. The medium of claim 17, wherein a user system and an analytic system are integrated based on the channel hierarchy and the resource hierarchy.

19. The medium of claim 17, wherein said optimizing is based in part on an ability of the enterprise to utilize the future resource results.

20. The medium of claim 17, wherein the absolute and marginal resource amounts for each macro-channel are adjusted based on qualities of at least one of: (i) channels, (ii) sub-channels, and (iii) macro-channels.

21. The medium of claim 17, wherein caps are imposed based on at least one of: (i) channels, (ii) sub-channels, and (iii) macro-channels.

22. The medium of claim 17, wherein the resource allocation tool communicates with a predictive analytic algorithm deployment infrastructure that includes: (i) an analytics computing environment data store, and (ii) an analytics environment computer to initiate deployment of a predictive analytic algorithm in an enterprise operations workflow.
